(19) United States
(12) Patent Application Publication
(10) Pub. No.: US 2010/0175325 A1
(43) Pub. Date: Jul. 15, 2010

(54) ROTATING CONTROL MECHANISM OF SHUTTER LOUVER

(75) Inventor: Lin CHEN, Dongguan City (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: NIEN MADE ENTERPRISE CO., LTD., Taichung City (TW)

(21) Appl. No.: 12/351,678

(22) Filed: Jan. 9, 2009

(51) Int. Cl. E06B 7/086; E06B 7/084

(52) U.S. Cl. 49/90.1; 52/473

(57) ABSTRACT

A rotating control mechanism of the shutter louver is disposed at a louver and includes an anchor, a bush, and a screw. The anchor has an opening end and a closed end, so as to form a first separating portion and a second separating portion respectively corresponding to a major axis in a radial direction of the louver. The bush has a cylinder portion neighboring to the frame and embedded in the counterbored hole of the frame, and an annular flange attached to the frame and the louver and/or the opening end of the anchor with both sides respectively. The screw passes through the counterbored hole and the bush in sequence to lock the anchor, such that the anchor moves towards the major axis direction of the louver and stops at a screw on an inner surface of the axial hole, so as to prevent the louver from cracking.

### BACKGROUND OF THE INVENTION

1. Field of Invention

The present invention relates to a rotating control mechanism of a shutter louver, and more particularly to a rotating control mechanism, in which two ends of a louver are pulled outwards, and a thrust for assembling the rotating control mechanism in an axial hole of the louver is only applied along a major axis in a radial direction of the louver, thereby preventing the louver from cracking and damaging due to the stress along the minor axis in the radial direction of the louver, and only one of the components needs to be replaced when changing new parts so as to reduce the cost.

2. Related Art

In a common shutter, a pin is usually pivoted between each louver and the frame, such that the louver is able to pivotally rotate about the frame and fixed at a preset position, so as to control the opening angle of each louver.

In US Patent Publication No. US6865847, a tension screw assembly mechanism is provided for keeping the louver of a shutter at a required position. A countersunk screw passes through the frame and is inserted in the louver along a pivotal line of the louver. A spring axially aligned with the countersunk screw is wound around the countersunk screw, and respectively pushes against the head portion of the countersunk screw and a counterbored hole on the frame. When the louver pivotally rotates to an opening or a closing state, the countersunk screw pivotally rotates together with the louver. The spring pushes the louver pin or the countersunk screw outwards along the pivotal line.

In the above structure, a frictional force exists between the countersunk screw and the frame, and counteracts the rotation of the louver. If the louver is too loosely assembled, for example, when the weight of a moving arm of a control rod resting on the louver drives the louver to rotate to the closing state, the countersunk screw is further locked in the louver and compresses the spring. Therefore, the frictional force against the rotation of the louver is increased. Though this tension screw assembly mechanism provides an infinite adjustment range of the louver position, it is inapplicable to shutters with hole strips adapted to assemble the louvers on the shutter. That is, after a long-time usage, the hole strip may be worn, and the frictional force cannot balance the weight making the louver rotate to the closing state. Moreover, when the spring is kept in the same compression state for an excessively long time, the elastic fatigue occurs, and the elasticity decreases accordingly. Thereby, the thrust on the countersunk screw and the counterbored hole of the frame is relatively reduced, and the louver cannot be placed at the required position. At this point, if the countersunk screw is further locked in, the louver may crack. Especially when made of a medium density fiber (MDF) board, the louver is more easily damaged.

In US Patent Publication No. US5887386, a conventional shutter having movable louvers is provided. In the structure, a wooden screw is locked in one of the stiles, and its inner guiding end protrudes into a corresponding slot so as to be engaged with the outer end of the louver pin. Besides, the louver pin is aligned through the slot. The wooden screw is adapted to drive a louver assembly towards another corresponding frame, and the louver assembly includes louvers and corresponding louver pins.

The depth that the wooden screw is locked into the frame is a scope that an end surface of the louver adjacent to the frame and an inner surface of the frame are compressed and stopped by a flange of the louver pin in the shutter. The compression degree depends on the frictional force between the flange and the end surface of the louver. After the assembly of the whole device is completed, a painting or similar process is also performed. Further referring to US Patent Publication No. US4887391, another technology is provided, in which a heavy spring is combined on one end or two ends of each louver pin, so as to maintain a required axial compression load and keep the louver on a set position.

In the above structure, the wooden screw presses against the inner end of the louver pin, so as to push the louver to stop on another frame. Through the frictional forces between the flange of the louver pin and one side edge of the louver neighboring to the frame and between the louver and the other frame, the louver may be placed at the required position. However, after a long-time usage, and when the frictional force therebetween is reduced, the wooden screw is further locked in. Although the normal force on the louver is increased, the louver may be bent due to over-push, such that the opening or closing action is not smooth and a light leak occurs, or the louver is broken, or the thread of the wooden screw is damaged. If the replacement is to be performed, the whole louver assembly, louver pin, or frame must be replaced, and the cost is quite high.

Therefore, the primary problem to be solved by the present invention is to design a structure, in which the spring and the tension elasticity are not required, so as to avoid the elastic fatigue and damage to the louver due to over-push, especially when the louver is made of the MDF board. As such, during the replacement, only the part needs to be replaced, and the frictional force is sustained, thus achieving the optimal louver rotation positioning control.

### SUMMARY OF THE INVENTION

In order to solve the above problem, the present invention is mainly directed to a rotating control mechanism of a shutter louver.

The present invention is also directed to only pushing the louver towards a major axis direction with a greater thickness after inserted with the rotating control mechanism, so as to prevent the louver from cracking when pushed towards a minor axis direction with a smaller thickness.

The present invention is further directed to only replacing one of the components instead of the whole rotating control mechanism when changing new parts, so as to reduce the production and manufacturing cost.

Accordingly, a rotating control mechanism of a shutter louver is provided. The shutter includes a top rail, a bottom rail, two stiles, a louver assembly, a rotating control mechanism, and a control rod. The two stiles spaced by a predetermined distance and disposed in parallel are joined to the top rail and the bottom rail. The louver assembly has several louvers arranged in parallel and perpendicular to the stiles. The control rod is connected to the louvers, and controls the rotation of the louvers. The rotating control mechanism is disposed between at least one of the louvers and at least one of the stiles. The frame has a counterbored hole corresponding to the rotating control mechanism. An end surface of the louver for disposing the rotating control mechanism has an oblong or elliptical axial hole, a major axis in a radial direction of the axial hole overlaps or is parallel with a major axis in a radial direction of the louver, and a minor axis in the radial direction of the axial hole overlaps or is parallel with a minor axis in the radial direction of the louver.

The rotating control mechanism includes an anchor, a bush, and a screw. The anchor has a hollow structure corresponding to the shape of the axial hole, and is plugged in the axial hole of the louver. The anchor has an opening end neighboring to the frame. The opening end is formed with a first separating portion and a second separating portion respectively corresponding to the major axis in the radial direction of the louver. The outer surfaces of the first separating portion and the second separating portion form several fin protruding portions outwards, and the inner surfaces of the first separating portion and the second separating portion form several fixing portions inwards. The bush, disposed between the frame and the louver, has a cylinder portion and an annular flange. The cylinder portion is embedded in the couterbored hole of the frame. The annular flange is disposed on one end of the bush neighboring to the louver and has a first side and a second side. The first side is attached to the frame, and the second side is attached to the louver and/or the opening end of the anchor. The screw is disposed on the frame. One end of the screw rests on the counterbored hole of the frame and the other end extends to the anchor through the bush, such that the screw is locked to the fixing portions. Thereby, the first separating portion and the second separating portion are forced to move towards the major axis in the radial direction of the louver, and the fin protruding portions are stopped on an inner surface of the axial hole.

Preferably, a cross section of the axial hole of the louver is oblong, the major axis in the radial direction of the oblong axial hole overlaps or is parallel with the major axis in the radial direction of the louver, and the minor axis in the radial direction of the oblong axial hole overlaps or is parallel with the minor axis in the radial direction of the louver. An outer cross section of the anchor is also oblong the same as the axial hole, and a cross section of the hollow structure in the anchor is round. A major axis in a radial direction of the anchor overlaps or is parallel with the major axis in the radial direction of the axial hole, a minor axis in the radial direction of the anchor overlaps or is parallel with the minor axis in the radial direction of the axial hole, and the first separating portion and the second separating portion are respectively located on the major axis in the radial direction of the anchor.

Preferably, the cross section of the axial hole of the louver is elliptical, the major axis in the radial direction of the elliptical axial hole overlaps or is parallel with the major axis in the radial direction of the louver, and the minor axis in the radial direction of the elliptical axial hole overlaps or is parallel with the minor axis in the radial direction of the louver. The outer cross section of the anchor is elliptical the same as the axial hole, and the cross section of the hollow structure in the anchor is round. The major axis in the radial direction of the anchor overlaps or is parallel with the major axis in the radial direction of the axial hole, the minor axis in the radial direction of the anchor overlaps or is parallel with the minor axis in the radial direction of the axial hole, and the first separating portion and the second separating portion are respectively located on the major axis in the radial direction of the anchor.

Therefore, through the above structure, when the rotating control mechanism is assembled on the louver, a thrust is applied on the major axis direction with the thicker thickness of the louver, so as to prevent the louver from cracking resulting from applying the thrust in the minor axis direction of the louver with the thinner thickness. During the part replacement, only one of the components, for example, the anchor made of a plastic material and/or the bush, is replaced, so as to reduce the production and manufacturing cost.

The features and practice of the preferred embodiments of the present invention will be illustrated in detail below with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is an exploded view of a shutter according to an embodiment of the present invention;

FIG. 2A is an exploded view of a rotating control mechanism according to the embodiment of the present invention;

FIG. 2B is a cross-sectional view of the rotating control mechanism according to the embodiment of the present invention;

FIG. 3 is a structural side view of an anchor according to the embodiment of the present invention;

FIG. 4 is an end view of an opening end of the anchor according to the embodiment of the present invention;

FIG. 5 is a structural view of the anchor having two ends being the closed end according to another embodiment of the present invention;

FIG. 6 is a structural view of the anchor having a flange according to still another embodiment of the present invention;

FIG. 7 is a structural combined view of an MDF louver according to the present invention; and

FIG. 8 is an exploded view of the MDF louver according to the present invention.

### DETAILED DESCRIPTION OF THE INVENTION

An embodiment of the present invention is illustrated in detail below with the accompanying drawings.

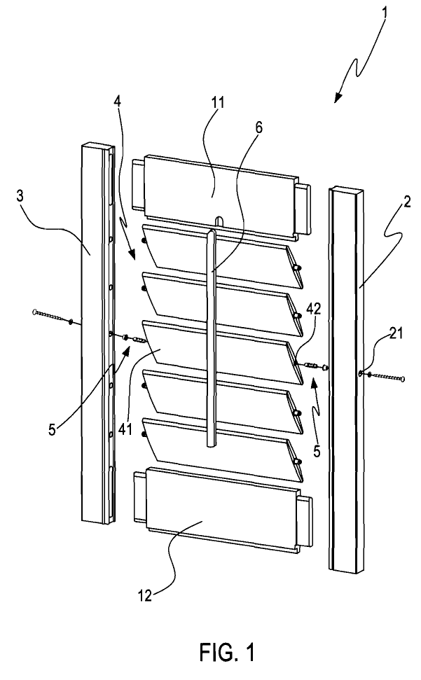

FIG. 1 is an exploded view of a shutter according to an embodiment of the present invention. A shutter 1 of the present invention includes a top rail 11, a bottom rail 12, two stiles 2 and 3, a louver assembly 4, a rotating control mechanism 5, and a control rod 6.

The two stiles 2 and 3 spaced by a predetermined distance and disposed in parallel are joined to the top rail 11 and the bottom rail 12. The louver assembly 4 composed of a plurality of louvers 41 is disposed between the two stiles 2 and 3. The louvers 41 are sequentially disposed in parallel from top to bottom (as shown in FIG. 1), and an axial direction of the louver 41 is perpendicular to that of the stiles 2 and 3. Moreover, an axial hole 42 is respectively formed on end surfaces of each louver 41 facing the two stiles 2 and 3, and the rotating control mechanism 5 is disposed between the stiles 2 and 3 and each louver 41 (or the louver assembly 4).

The control rod 6 is connected to a central position of each louver 41 (or the louver assembly 4), and an axial direction of the control rod 6 is perpendicular to that of each louver 41 (or the louver assembly 4), that is, the axial direction of the control rod 6 is parallel with that of the stiles 2 and 3. Therefore, the control rod 6 controls the rotation of each louver 41 to open/close the louver assembly 4, and meanwhile places the louver assembly 4 at a required position during rotation through the rotating control mechanism 5.

In order to reduce the production and manufacturing cost, the rotating control mechanism may be only assembled on one of the louvers in the louver assembly, the remaining louvers still adopt the conventional louver pins, and the same louver rotation positioning function can be achieved. Moreover, the stress degree from the user is lower than the circumstance that the rotating control mechanism is assembled on each louver, especially when the rotating control mechanism is assembled on the louver at a perpendicular position close to the center. Therefore, in this embodiment, the above structure is adopted for illustration.

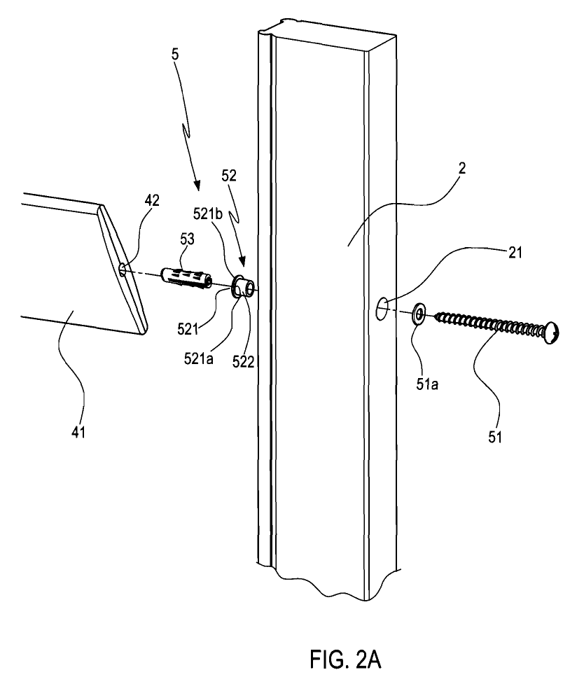

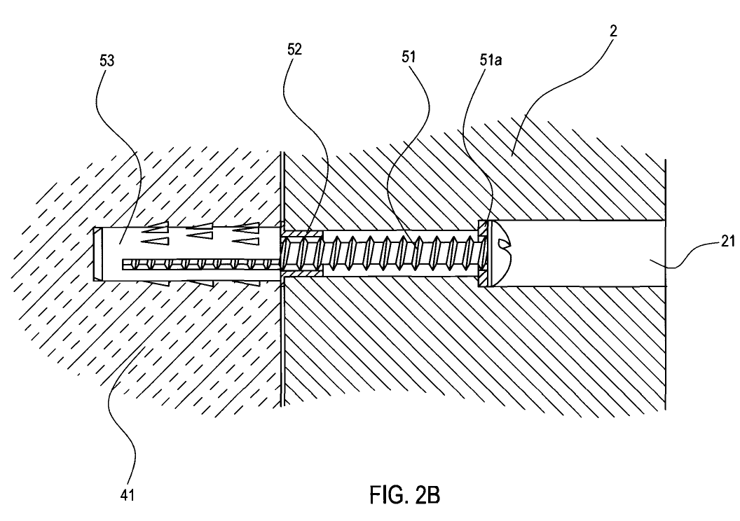

FIGS. 2A and 2B are respectively an exploded view and a cross-sectional view of the rotating control mechanism according to the embodiment of the present invention. The rotating control mechanism 5 of this embodiment includes a screw 51, a bush 52, and an anchor 53.

The bush 52, disposed between the louver 41 and the frame 2, has a first end forming an annular flange 521 neighboring to the louver 41, and a second end as a cylinder portion 522 neighboring to the frame 2. The frame 2 has a counterbored hole 21, and the cylinder portion 522 of the bush 52 is embedded in the counterbored hole 21. A first side 521a of the annular flange 521 neighboring to the frame 2 may be attached to a surface of the frame 2, and a second side 521b away from the frame 2 may be attached to the end surface of the louver 41 opposite to the frame 2 and/or attached to an opening end 53a of the anchor 53.

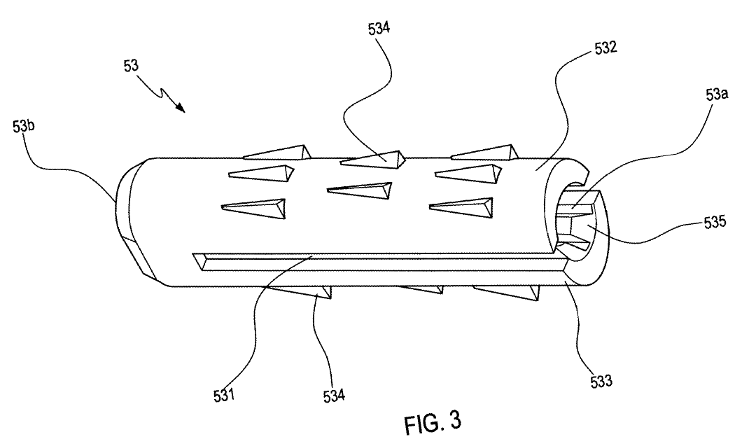

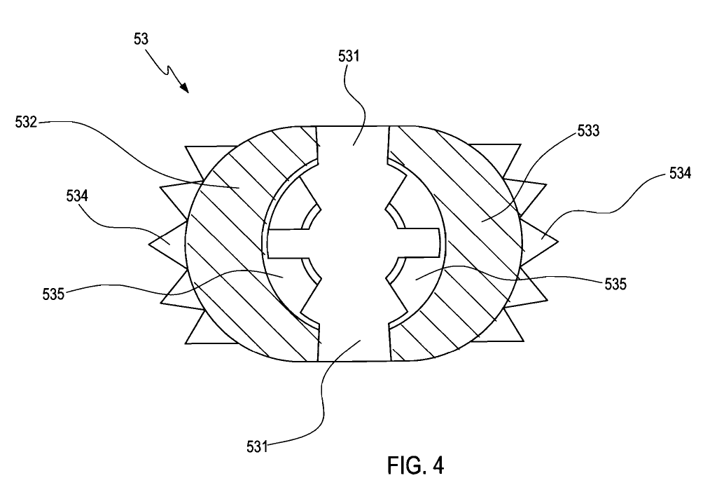

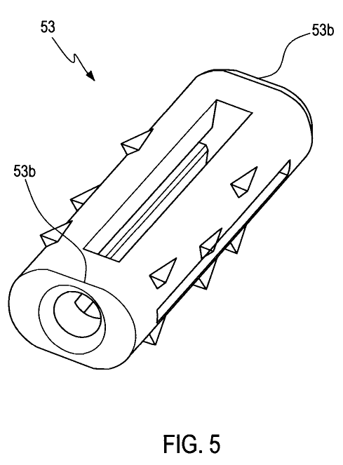

FIGS. 3 and 4 are respectively a structural side view of the anchor and an end view of the opening end thereof according to the embodiment of the present invention. The anchor 53 is a hollow structure made of a plastic material. The outer cross section of the anchor 53 is approximately oblong or elliptical (the latter is employed as an example for illustration in this embodiment), and an inner cross section thereof is round. One end of the anchor 53 neighboring to the frame 2 is the opening end 53a, and the other end of the anchor 53 neighboring to the louver 41 is a closed end 53b. In this embodiment, the anchor 53 has the opening end 53a and the closed end 53b for the subsequent detailed description, but the present invention is not limited thereto. For example, as shown in FIG. 5, both of the two ends of the anchor 53 are closed ends 53b.

On two end edges of the anchor 53 on a minor axis direction, a notch 531 is respectively formed from the opening end 53a to the closed end 53, such that the opening end 53a is divided into a first separating portion 532 and a second separating portion 533 towards a major axis direction. The outer surfaces of the first separating portion 532 and the second separating portion 533 form a plurality of fin protruding portions 534 outwards, and the inner surfaces thereof form a plurality of fixing portions 535 inwards.

The axial hole 42 of the louver 41 is corresponding to the cross section of the anchor 53 and is oblong. A major axis of the axial hole 42 overlaps a major axis of the louver 41, and a minor axis of the axial hole 42 overlaps a minor axis of the louver 41. The closed end 53b of the anchor 53 is plugged in the axial hole 42, a major axis of the anchor 53 overlaps or is parallel with the major axis of the axial hole 42, and a minor axis of the anchor 53 overlaps or is parallel with the minor axis of the axial hole 42.

The structure on one side of the frame 3 is the same as that on one side of the frame 2, so the details will not be given herein again.

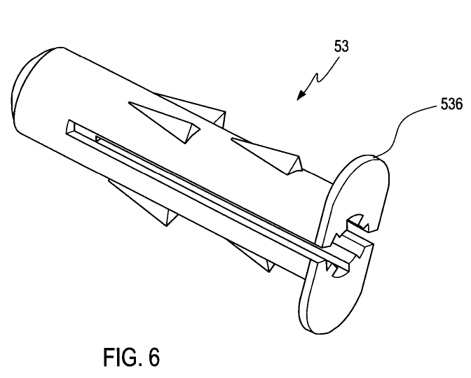

FIG. 6 is a structural view of the anchor having a flange according to another embodiment of the present invention. The anchor 53 may also form a radially protruding flange 536 on an end neighboring to the frame 2, so as to lean against the frame 2. The flange 536 is oblong or elliptical, and the major axis in the radial direction is parallel to or overlaps the major axis in the radial direction of the louver. As the anchor 53 has the fin protruding portion 534 for being fixed on the inner lateral side of the axial hole 42, the shape of the anchor 53 may also be round (not shown).

During the assembly, the closed end 53b of the anchor 53 is plugged in the axial hole 42 of the louver 41. The screw 51 passes through the counterbored hole 21 of the frame 2 and the cylinder portion 522 of the bush 52, penetrates from the opening end 53b of the anchor 53, and stops at the closed end 53b. When penetrating and locked in the lock anchor 53, the screw 51 pushes the fixing portions 535 of the anchor 53 outwards, such that the first separating portion 532 and the second separating portion 533 move towards the major axis direction of the anchor 53 and the louver 41. The fin protruding portions 534 stop at an inner lateral side of the axial hole 42, so as to fix the anchor 53 and prevent the anchor 53 and the louver 41 moving relative to each other. The first separating portion 532 and the second separating portion 533 move towards the major axis direction of the anchor 53 and the louver 41. Thereby, the louver 41 is prevented from cracking at thinner positions in the minor axis direction as the thickness of the louver 41 along the major axis direction is greater.

Further, the first side 521a of the annular flange 521 of the bush 52 is attached to the surface of the frame 2 to generate the frictional force, and the second side 521b is attached to the end surface of the louver 41 opposite to the frame 2 to generate the frictional force. Therefore, after the screw 51 is locked in the anchor 53 and the anchor 53 is fixed by the fin protruding portions 534, the louver 41 is pulled towards the frame 2, such that the frictional forces generated by attaching the first side 521a of the annular flange 521 of the bush 52 to the surface of the frame 2 and attaching the second side 521b to the end surface of the louver 41 opposite to the frame 2 are increased, thus achieving the louver rotation positioning function. After a long-time usage and the part replacement is required, as the anchor 53 is made of a plastic material, when the screw is detached from the anchor 53, the first separating portion 532 and the second separating portion 533 are moved to make the fin protruding portion 534 away from the inner surface of the axial hole 42, so as to easily disassemble the anchor 53 for replacement. If the frictional force at the annular flange 521 of the bush 52 becomes weak, the replacement may be performed at the same time. In this manner, only a single part needs to be replaced instead of the whole assembly, and thus the cost is reduced.

Meanwhile, in the present invention, the screw 51 “pulls” to make frictional forces generated between the louver 41 and the annular flange 521 and between the annular flange 521 and the frame 2, instead of pushing the louver 41. Thereby, the louver 41 is prevented from being bent and causing light leak. The annular flange 521 can be made as thin as possible to further prevent the light leak.

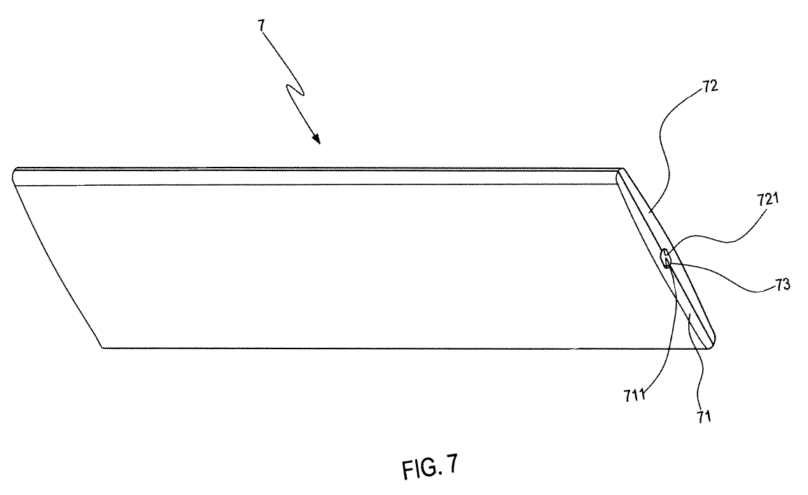

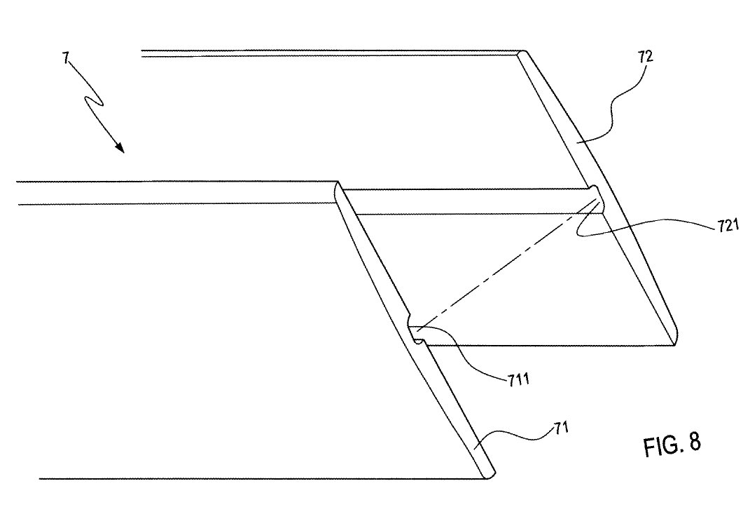

FIGS. 7 and 8 are respectively a structural combined view and an exploded view of the MDF louver according to the present invention. Currently, the louver is generally made of an MDF board. The MDF board is a type of man-made board fabricated by wooden fiber mixed with resin under high temperature and high pressure. Thereby, the MDF board is advantageous in being high in density, not easily deformed nor damaged by worms, and having a smooth surface. In addition, the raw material of the MDF board is recycled wooden scraps, such that the natural wood material resource is saved, and forests on the globe are directly protected, thereby protecting the environment.

The structure of the MDF louver 7 is formed by joining (adhering) an upper plywood 71 to a lower plywood 72. On one lateral side of the upper plywood 71 opposite to the lower plywood 72 and on one lateral side of the lower plywood 72 opposite to the upper plywood 71, a groove 711 and a groove 721 are respectively formed on the major axis direction. By joining the upper plywood 71 to the lower plywood 72, the grooves 711 and 721 are combined to form an axial hole 73. That is, the joining line of the MDF louver 7 overlaps or is parallel with the major axis in the radial direction of the louver 7.

Therefore, when the louver rotating control mechanism 5 of the present invention is assembled to the MDF louver 7, the first separating portion 532 and the second separating portion 533 of the anchor 53 stretch outwards along the major axis in the radial direction, so as to separate the upper plywood 71 from the lower plywood 72 without affecting the joining line, and prevent the louver 7 from cracking at thinner positions along the minor axis in the radial direction.

In addition, the MDF louver may also be an integrally formed louver (not shown) with two end edges processed to form the axial holes, so as to achieve the same efficacy as the MDF louver having the upper plywood 71 and the lower plywood 72 combined with each other.

Definitely, the present invention may also be applied to a louver made of a wooden plate or plastic, for example, an acrylonitrile butadiene styrene (ABS) foaming louver, and the same function as that of the louver made of the MDF board may be more easily achieved. Thereby, when the louver 41 is made of a common natural wood material, the axial hole 42 is manually drilled during the fabrication.

A method for assembling the rotating control mechanism of the shutter of the present invention includes the following steps.

In Step S1, the anchor 53 is plugged in the axial hole 42 of the louver 41, such that the major axis in the radial direction of the anchor 53 is parallel with or overlaps the major axis in the radial direction of the louver 41, the minor axis in the radial direction of the anchor 53 is parallel with or overlaps the minor axis in the radial direction of the axial hole 42 and the louver 41, and the first separating portion 532 and the second separating portion 533 are located on the major axis in the radial direction of the anchor 53.

In Step S2, the cylinder portion 522 of the bush 52 is plugged in one side of the couterbored hole 21 of the frame 2 neighboring to the louver 41, and the annular flange 521 is attached to one side of the frame 2 neighboring to the louver 41.

In Step S3, the screw 51 penetrates from one side of the counterbored hole 21 of the frame 2 away from the louver 41, passes through the counterbored hole 21 of the frame 2, the bush 52, and the anchor 53 plugged in the axial hole 42 of the louver 41 in sequence, stops at the closed end 53b of the anchor 53, and is fixed by the fixing portions 535 of the anchor 53. The first side 521a and the second side 521b of the annular flange 521 are respectively attached to one side of the frame 2 neighboring to the louver 41 and one side of the louver 41 neighboring to the frame 2, so as to generate the frictional force. When the screw 51 passes through the anchor 53, the first separating portion 532 and the second separating portion 533 of the anchor 53 are driven away from each other towards opposite directions along the major axis in the radial direction of the axial hole 42 of the louver 41, such that the fin protruding portions 534 of the anchor 53 are embedded in the inner side wall of the axial hole 42, and the anchor 53 is fixed in the axial hole 42.

Generally, when the screw is used, a washer is matched, such that that screw is more firmly secured. Therefore, in Step S3, before penetrating the screw 51 from one side of the counterbored hole 21 of the frame 2 away from the louver 41, a sub-step S31 is performed as follows. First, a washer 51a (as shown in FIG. 2A) is placed in one end of the counterbored hole 21 towards the outer side of the frame 2. Then, the screw passes through the counterbored hole 21 of the frame 2, the bush 52, and the anchor 53 plugged in the axial hole 42 of the louver 41 in sequence.

The material of the louver 41 may be a common natural wood material or MDF board. If the louver 41 is made of a common natural wood material or plastic, the axial hole 42 is manually drilled during the fabrication. If the louver 41 is made of the MDF board, as shown in FIGS. 7 and 8, the structure is formed by joining (adhering) the upper plywood 71 with the lower plywood 72. Moreover, on one lateral side of the upper plywood 71 opposite to the lower plywood 72 and one lateral side of the lower plywood 72 opposite to the upper plywood 71, a groove 711 and a groove 721 are respectively formed on the major axis direction. By joining the upper plywood 71 to the lower plywood 72, the grooves 711 and 721 are combined to form the axial hole 73. That is, the joining line of the MDF louver 7 overlaps or is parallel with the major axis in the radial direction of the louver 7.

In addition, the MDF louver may also be an integrally formed louver (not shown) with two end edges processed to form the axial holes, so as to achieve the same efficacy as the MDF louver having the upper plywood and the lower plywood combined with each other.

Therefore, when the louver rotating control mechanism 5 of the present invention is assembled to the MDF louver 7, the first separating portion 532 and the second separating portion 533 of the anchor 53 stretch outwards along the major axis in the radial direction, so as to separate the upper plywood 71 from the lower plywood 72 without affecting the joining line, and prevent the louver 7 from cracking at thinner positions along the minor axis in the radial direction.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rotating control mechanism of a shutter louver, wherein the shutter comprises a top rail, a bottom rail, two stiles, a louver assembly, a rotating control mechanism, and a control rod,
the two stiles spaced by a predetermined distance and disposed in parallel are joined to the top rail and the bottom rail;
the louver assembly has several louvers arranged in parallel and perpendicular to the stiles, the louvers are respectively pivoted between the stiles, and cross sections of the louvers are flat;
the control rod is connected to the louvers, for controlling the rotation of the louvers;
the rotating control mechanism is disposed between at least one of the louvers and at least one of the stiles;
the frame has a counterbored hole corresponding to the rotating control mechanism; and
an end surface of the louver for disposing the rotating control mechanism has an oblong or elliptical axial hole, a major axis along a radial direction of the axial hole overlaps or is parallel with a major axis along a radial direction of the louver, and a minor axis in the radial direction of the axial hole overlaps or is parallel with a minor axis in the radial direction of the louver;
the rotating control mechanism comprising:
an anchor, having a hollow structure corresponding to the shape of the axial hole, provided with an oblong or elliptical cross section, and plugged in the axial hole of the louver, wherein two sides of the minor axis in the radial direction of the anchor respectively have a notch, so as to form a first separating portion and a second separating portion opposite to each other on the major axis in the radial direction of the louver, outer surfaces of the first separating portion and the second separating portion form several fin protruding portions outwards, and inner surfaces of the first separating portion and the second separating portion form at least one fixing portion inwards; and
a screw, disposed on the frame, wherein one end of the screw rests on the counterbored hole of the frame and the other end extends to the anchor through the counterbored hole, such that the screw is locked to the fixing portions, the first separating portion and the second separating portion are forced to move towards the major axis in the radial direction of the louver, and the fin protruding portions are stopped on an inner surface of the axial hole.

2. The rotating control mechanism of a shutter louver according to claim 1, wherein the louver is made of a medium density fiber (MDF) board.

3. The rotating control mechanism of a shutter louver according to claim 1, wherein one end of the anchor is a closed end, the other end is an opening end, and the notch extends from the opening end towards the direction of the closed end.

4. The rotating control mechanism of a shutter louver according to claim 3, wherein the opening end of the anchor is located on an end neighboring to the frame.

5. The rotating control mechanism of a shutter louver according to claim 1, wherein the anchor forms a radially protruding flange on an end neighboring to the frame, so as to lean against the frame.

6. The rotating control mechanism of a shutter louver according to claim 1, wherein the rotating control mechanism further comprises a bush disposed between the frame and the louver and having a cylinder portion and an annular flange, wherein the cylinder portion is embedded in the couterbored hole of the frame, the annular flange is disposed on one end of the bush neighboring to the louver and has a first side and a second side, the first side is attached to the frame, and the second side is attached to the louver and/or the opening end of the anchor.

7. An anchor structure, being an elongated hollow structure, provided with an oblong or elliptical cross section, having a notch penetrating inwards on two sides of a minor axis in the radial direction respectively, and forming a first separating portion and a second separating portion in a major axis along the radial direction respectively, wherein outer surfaces of the first separating portion and the second separating portion form several fin protruding portions outwards, and inner surfaces of the first separating portion and the second separating portion form at least one fixing portion inwards.

8. The anchor structure according to claim 7, wherein one end of the anchor is a closed end, the other end is an opening end, and each notch extends from the opening end towards the direction of the closed end.

9. The anchor structure according to claim 8, wherein the first separating portion and the second separating portion of the anchor respectively form a radially protruding flange on an end neighboring to the opening end.

10. A rotating control mechanism of a shutter louver, wherein the shutter comprises a top rail, a bottom rail, two stiles, a louver assembly, a rotating control mechanism, and a control rod,
the two stiles spaced by a predetermined distance and disposed in parallel are joined to the top rail and the bottom rail;
the louver assembly has several louvers arranged in parallel and perpendicular to the stiles, the louvers are respectively pivoted between the stiles, and cross sections of the louvers are flat;
the control rod is connected to the louvers, for controlling the rotation of the louvers;
the rotating control mechanism is disposed between at least one of the louvers and at least one of the stiles;
the frame has a counterbored hole corresponding to the rotating control mechanism; and
an end surface of the louver neighboring to the frame for disposing the rotating control mechanism has a round axial hole;
the rotating control mechanism comprising:
an anchor, having a hollow structure corresponding to the shape of the axial hole, provided with a round cross section, and plugged in the axial hole of the louver, wherein one end neighboring to the frame forms a radially protruding oblong or elliptical flange, two sides of a minor axis in the radial direction of the flange respectively have a notch so as to form a first separating portion and a second separating portion opposite to each other in a major axis along the radial direction of the louver, outer surfaces of the first separating portion and the second separating portion form several fin protruding portions outwards, and inner surfaces of the first separating portion and the second separating portion form at least one fixing portion inwards; and
a screw, disposed on the frame, wherein one end of the screw rests on the counterbored hole of the frame and the other end extends to the anchor through the counterbored hole, such that the screw is locked to the fixing portions, the first separating portion and the second separating portion are forced to move towards the major axis in the radial direction of the louver, and the fin protruding portions are stopped on an inner surface of the axial hole.

11. The rotating control mechanism of a shutter louver according to claim 10, wherein one end of the anchor is a closed end, the other end is an opening end, and the notch extends from the opening end towards the direction of the closed end.

12. The rotating control mechanism of a shutter louver according to claim 11, wherein the opening end of the anchor is located on an end neighboring to the frame.

13. An anchor structure, being an elongated hollow structure, provided with a round cross section, forming a radially protruding oblong or elliptical flange on one end neighboring to the frame, having a notch penetrating inwards on two sides of a minor axis in the radial direction of the flange respectively, and forming a first separating portion and a second separating portion on a major axis in the radial direction of the flange respectively, wherein outer surface of the first separating portion and the second separating portion form several fin protruding portions outwards, and inner surfaces of the first separating portion and the second separating portion form at least one fixing portion inwards.

14. The anchor structure according to claim 13, wherein one end of the anchor is a closed end, the other end is an opening end, and each notch extends from the opening end towards the direction of the closed end.

15. The anchor structure according to claim 14, wherein the first separating portion and the second separating portion of the anchor respectively form a radially protruding flange on an end neighboring to the opening end.
